(19) United States
(12) Patent Application Publication
(10) Pub. No.: US 2008/0030486 A1
(43) Pub. Date: Feb. 7, 2008

(54) Multi-functional pen input device

(75) Inventor: John T. Cook, Boulder, CO (US)

Correspondence Address: John T. Cook, 2424 Mapleton Avenue, Boulder, CO, 80304, US

(73) Assignee: Quiteso Technologies, LLC

(21) Appl. No.: 11/499,378

(22) Filed: Aug. 4, 2006

(51) Int. Cl. G06F 3/033

(52) U.S. Cl. 345/179

(57) ABSTRACT

A multi-function pen input device is disclosed which includes a conventional pen input device for use on a paper medium, such as a ball point pen and/or a pencil lead feeder, and an active stylus for use with a paperless medium, carried in a single housing which includes a cap portion and a barrel portion. Unlike known pen input devices, the multi-function pen input device in accordance with the present invention can be used with electronic devices that include a digitizing tablet. In one embodiment of the invention, the multi-function pen input device further includes an electronic circuit that enables it to be used as pen input device for virtual writing surfaces and transmit signals to a remote PC. In all embodiments, a cam arrangement is provided that selectively and alternatively allows the ball point pen and/or pencil lead feeder as well active stylus to be placed in a use position, for example, by way of a relatively simple twist of the cap portion with respect to the barrel portion.

### BACKGROUND OF THE INVENTION

1. Field of the Invention

The present invention relates to a multi-functional pen input device and more particularly to a pen input device for writing on a paper medium, such as a ball point pen and/or a mechanical pencil, and an active stylus and optionally a pen input device for use on a virtual medium, housed in a single housing.

2. Description of the Prior Art

Various pen input devices are known in the art known for use as input devices on paper and paperless mediums. Ball point pens and mechanical pencils are but a few of the known pen input devices available for paper mediums. Both passive and active stylus devices are known to be used as pen input devices on paperless mediums.

For example, passive stylus devices are known to be used in various electronics devices, such as, personal digital assistants (PDAs) and other electronics devices that include touch screen displays that have a touch-sensitive transparent panel covering the screen. Such passive stylus devices are often configured in a housing similar to a ball point pen and include a stylus generally formed in the shape of a ball point ink cartridge but which contains no ink and is formed from a material that will not scratch the surface of a touch screen display. Such passive stylus devises are described in U.S. Pat. No. 5,654,529, hereby incorporated by reference.

Active stylus devices are also known. As used herein, such active or electronic stylus devices are defined as devices used with digitizing tablets. An active stylus also looks like a simple ball point pen but uses an electronic head instead of ink. The digitizing tablet contains electronics that enable it to detect movement of the cursor or pen and translate the movements into digital signals. In particular, the digitizing tablet includes a writing surface that is configured to sense electromagnetic energy as well as the location on the writing surface where the electromagnetic energy is directed. An active stylus is used to generate electromagnetic energy that is sensed by the writing surface as the stylus moves there across. Some known active stylus devices are battery powered. Others do not contain a battery and generate electromagnetic energy by various means including by way of a permanent magnet. Example of such an active stylus is disclosed in: U.S. Pat. No. 6,806,867; US Patent Application Publication No. US 2004/0125089 A1 and US Patent Application Publication No. US 2006/0158440 A1, hereby incorporated by reference.

Such active and passive stylus are used as input devices directly on the surface of the touch screen display or digitizing tablet, respectively. Still other pen input devices are known for use as input devices for writing on a virtual medium. Such writing devices are similar to ball point pens and include sensors for recording movements of the pen on a virtual writing surface in the X, Y and Z planes, which is transmitted to a PC either by wire or wirelessly and converted to digital signals. Examples of such systems are disclosed in U.S. Pat. Nos. 6,577,299; 6,603,464; and 6,633,282; as well as US Patent Application Publication Nos.: US 2002/0011989 A1; US 2002/0163511 A1; US 2004/0125089 A1; US 2004/0140962 A1 and US 2005/0024690 A1.

In general, these systems include wireless pen input devices that are linked with a remote computer system and are configured to transmit pen down events including handwriting to the remote computer system for recordation. Various types of such pen input devices are known. For example, optical, inertial and track ball pen input devices are known. Examples of inertial pen input devices are disclosed in US Patent Application Publication No. US 2004/0140962 and 2004/0125089; as well as U.S. Pat. Nos. 6,577,299. Examples of optical pen input devices are disclosed in US Patent Application Publication Nos.: US 2002/0011989 and US 2005/0024690 and U.S. Pat. No. 6,603,464. Chao et al US Patent Application Publication No. US 2004/0125089 also discloses an optical type pen input device which can also be used as an active stylus. An example of a track ball type pen input device is disclosed in U.S. Pat. No. 6,633,282, all hereby incorporated by reference.

Inertial type pen input devices normally utilize inertial signals from accelerometers to determine the coordinates of the pen input device on an actual or virtual writing surface. For example, Wang et al published US patent application no. US 2004/0140962 A1 discloses a computer system which includes a pen input device for use in both physical ink and non-ink applications. The input device includes an ink cartridge, a pressure sensor a plurality of accelerometers, a gyroscope, a processor, a memory, a transceiver, a power supply and a display. In non-ink applications, virtually any surface can be used as a virtual writing surface or tablet. In a calibration mode, the system sets the inertial co-ordinates equal to virtual paper coordinates. As the pen input device is moved across a virtual writing surface, inertial signals from the accelerometers are used to calculate the inertial coordinates of the pen input device. The inertial coordinates are used to calculate virtual paper coordinates. In situations where the velocity of the pen input device is constant, the signals from the accelerometers will be relatively inaccurate. In those situations, signals from the gyroscope are used to enhance the accuracy of the inertial signals from the accelerometers. The coordinate signals and thus the path of the pen input device, for example, handwriting, along the virtual writing surface are transmitted to a remote computer system and recorded.

Schiller et al. U.S. Pat. No. 6,577,299 relates to another inertial type pen input device. The pen input device disclosed in the '299 patent is configured to wirelessly transmit coordinate signals from the pen input device to a remote computer system. The '299 patent discloses the use of at least two reflectors that are placed along the edges of a piece of paper. A beacon, such as an ultrasonic, infrared, or RF beacon, is located on the pen input device so as to be in communication with the reflectors. The signals reflected from the reflectors are measured to determine their energy and time of flight in order to determine the reference coordinates of the pen input device. Once the reference coordinates are determined, the system utilizes inertial signals from a plurality of accelerometers and a gyroscope to determine the path of the pen input device. As such, the system is able to record handwriting on a virtual or actual writing surface. The beacon is used to periodically calibrate the coordinates of the pen input device.

U.S. Pat. No. 6,633,282 B1 to Monroe discloses a track ball type pen input device. In particular, the '282 patent discloses a track ball located in the tip of the pen input device. The movement of the pen input device across an actual or virtual writing surface is sensed in a similar manner as mouse with a track ball. The pen input device is configured with an outward appearance resembling a standard ball point pen, which optionally operates as a standard ball point pen and as a pen input device. When operated as a pen input device, the position signals of the track ball are transmitted back to the computer system and recorded to record the path of the trackball along the virtual writing surface.

As mentioned above optical pen input devices are also known. US Patent Application Publication No. US 2002/0011989 A1 to Ericson et al is an example of an optical type pen input device. Such optical pen input devices include an optical scanner. An optical waypoint is used to enable the pen input device to determine its relative position relative to the data, for example, handwriting, to be scanned. The optical waypoint is provided as a pattern of dots on the writing surface. The pen input device scans the dot pattern and identifies it by conventional optical character recognition (OCR) techniques. As such, the pen input device is able to scan handwritten data and transmit it to a remote computer system along with the paper coordinates of the scanned data. The pen input device is also able to provide various properties to the scanned data, such as, underline, color, line width, yellow mark, secret, and personal and/or by perform an action on the scanned data, such as, encryption, sending an email or facsimile message, etc.

US Patent Application Publication No. US 2002/0163511 A1 to Sekendur is another example of an optical pen input device. That pen input device includes a scanner, such as a digital camera or a charge-coupled device (CCD) for scanning optical data, such as handwriting data. With such optical pen input devices, optical waypoints are provided at one or more specific locations on the writing surface. The pen input device scans and identifies those waypoints. The waypoints are used to provide an x-y reference coordinate position so that the movement of the pen input device on the writing surface (e.g., paper) can be referenced to those waypoints.

US Patent Application Publication No. US 2005/0024690 A1 to Picciotto et al. is another example of an optical type pen input device. In addition to waypoints, the '690 publication discloses a pen input device which also uses a velocity sensor for sensing speed and relative direction information of the writing tip over a writing surface. Data, such as handwriting data, is scanned by an optical scanner and transmitted to a computer system.

Rabin U.S. Pat. No. 6,603,464 B1 also relates to an optical pen input device for sensing handwriting and other pen down events and transmitting that data wirelessly to a remote computer system. The pen input device is configured to be used with forms to record handwriting or other data physically written on the form. The pen input device includes a scanner for scanning handwriting and other pen down events on special forms which include one or more optical waypoints at predetermined coordinates on the form. These optical waypoints are sensed and identified by conventional optical character recognition techniques. The optical waypoints provide a reference point for the pen input device. As such as handwriting and other data is scanned, the relative position of the scanned data relative to the form is determined relative to the waypoints. In this application each form to be scanned is divided into a number of fields. Each field is provided with a reference or waypoint. As such, data in each field on the form along with its reference point. The scanned data is stored in a database and may be used to provide an electronic version of a completed form.

Optical pen input devices are limited to applications where pen input data can be scanned and thus can only be used in physical writing surface applications. As such, optical type pen input devices are becoming increasingly less desirable in paperless office applications. Although track ball and inertial type pen input devices are not so limited in application, many applications, such as medical applications, are still form based. Heretofore, form based applications have only been handled with optical type pen input devices which are limited in application to physical forms. Thus, there is a need for a pen input device for use in a paperless environment.

Still other pen input devices are known which includes sensors for transmitting movements of a ball point pen on a paper medium to a PC. Examples of such pen input devices are disclosed in US Patent Application Publication No. US 2004/0113896 A1 and U.S. Pat. No. 6,633,282, hereby incorporated by reference. Such a device includes a ball point pen and sensors for transmitting the movement of the ball point to a remote PC wirelessly.

In order to facilitate the use of various paperless pen input devices, it is known to combine certain paperless pen input devices with a ball point pen in a single housing. For example, U.S. Pat. No. 6,450,721 and US Patent Application Publication Nos.: US 2006/0083579 A1 and US 2006/0143874 A1 discloses combination devices, which include a ball point pen and a passive stylus. In these devices, a passive stylus tip is disposed on one end of a ball point pen opposite the tip of the ball point pen. U.S. Pat. No. 6,412,998 also discloses a combination ball point pen and passive stylus while U.S. Pat. No. 6,749,354 discloses a combination device that includes pencil lead feeder and a ball point pen which ride on a rotary cam which allows one or the other of the ball point pen or pencil lead feeder to drop down into a writing position when the pen housing is twisted. A passive stylus tip is disposed on an opposing end of the pen under the pen cap.

Unfortunately, such combination pen input devices which include a ball point pen or a pencil lead feeder or both are only included with passive stylus devices and thus only have limited utility with electronic devices having touch screen displays and are not useful for devices requiring an active stylus, such as a digitizing tablet. Thus, there is a need for a multi-function pen input device that can be used with devices requiring an active stylus.

### SUMMARY OF THE INVENTION

The present invention relates to a multi-function pen input device. In accordance with the present invention the multi-function pen input device includes a pen input device for use on a paper medium, such as a ball point pen and/or a pencil lead feeder, and an active stylus for use with a paperless medium, carried in a single housing which includes a cap portion and a barrel portion Unlike known pen input devices, the multi-function pen input device in accordance with the present invention can be used with electronic devices that include a digitizing tablet. In one embodiment of the invention, the multi-function pen input device further includes an electronic circuit that enables it to be used as pen input device for virtual writing surfaces and transmit signals to a remote PC (hereinafter referred to as “recordation electronics”). In all embodiments, a cam arrangement is provided that selectively and alternatively allows the ball point pen and/or pencil lead feeder as well active stylus to be placed in a use position, for example, by way of a relatively simple twist of the cap portion with respect to the barrel portion.

### DESCRIPTION OF THE DRAWING

These and other advantages of the present invention will be readily understood with reference to the following specification and attached drawing wherein:

FIG. 1 is an elevational view of one embodiment of the multi-functional pen input device shown in section illustrating a ball point pen cartridge, an active stylus and optional recordation electronics.

FIG. 2 is an exploded isometric view of the multi-functional pen input device, illustrated in FIG. 1.

FIG. 3 is a cross-sectional view along line 3-3 of FIG. 1.

FIG. 4a is a two-dimensional elevational view of an exemplary cam for use with the multi-functional pen input device illustrated in FIG. 1.

FIG. 4b is an isometric view of the exemplary cam illustrated in FIG. 4a.

FIG. 5a is a diagram illustrating the positions of the respective ball point pen cartridge and the active stylus, shown with the cam in phantom for a condition when the ball point pen cartridge is in a use or extended position and the active stylus is in a retracted position.

FIG. 5b is similar to FIG. 5a but for a condition when both the ball point pen cartridge and the active stylus are in retracted positions.

FIG. 6 is a elevational view of another embodiment of the multi-functional pen input device shown in section illustrating a pencil lead feeder, an active stylus and optional recordation electronics

FIG. 7a is a two-dimensional elevational view of an exemplary cam for use with the multi-functional pen input device illustrated in FIG. 6.

FIG. 7b is an isometric view of the exemplary cam illustrated in FIG. 7a.

FIG. 8 is a diagram illustrating the positions of the respective pencil lead feeder and the active stylus, shown with the cam in phantom for a condition when the pencil lead feeder is in a use or extended position and the active stylus is in a retracted position which also illustrates how pencil lead is advanced in the pencil lead feeder.

FIG. 9 is an exploded isometric view of a third embodiment of the multi-functional pen input device illustrating a ball point pen cartridge, a pencil lead feeder, an active stylus and optional recordation electronics.

FIG. 10a is a two-dimensional elevational view of an exemplary cam for use with the multi-functional pen input device illustrated in FIG. 9.

FIG. 10b is an isometric view of the exemplary cam illustrated in FIG. 10a.

FIG. 11 is a diagram illustrating the positions of the respective pencil lead feeder, ball point pen cartridge and the active stylus, shown with the cam in phantom for a condition when the pencil lead feeder is in a use or extended position and the ball point pen and the active stylus are in a retracted position and the pencil lead feeder spring is compressed.

FIG. 12 is similar to FIG. 11 but for a condition when the pencil lead feeder spring is in a relaxed position and both the ball point pen cartridge and the active stylus are in retracted positions.

FIG. 13 is similar to FIG. 11 but for a condition when both the pencil lead feeder cartridge and the active stylus are in a retracted position and the ball point pen cartridge is in an extended position.

FIG. 14 is similar to FIG. 11 but for a condition when both the ball point pen cartridge and the pencil feeder cartridge are in a retracted position and the active stylus is in an extended position.

FIG. 15a is a two-dimensional elevational view of a two-piece exemplary cam for use with the multi-functional pen input device illustrated in FIG. 9, formed with cam surfaces similar to FIG. 10a.

FIG. 15b is an exploded isometric view of the two-piece cam illustrated in FIG. 15a and a housing portion.

FIG. 15c is an assembled view of the two-piece cam illustrated in FIG. 15b, shown with the housing portion in phantom.

### DETAILED DESCRIPTION

The present invention relates to a multi-function pen input device. In accordance with the present invention, the multi-function pen input device includes a conventional pen input device for use on a paper medium, such as a ball point pen and/or a pencil lead feeder, and an active stylus, for use with a paperless medium, carried in a single housing which includes a cap portion and a barrel Portion. Unlike known pen input devices, the multi-function pen input device in accordance with the present invention can be used with electronic devices that include a digitizing tablet. In one embodiment of the invention, the multi-function pen input device further includes an electronic circuit that enables it to be used as pen input device for virtual writing surfaces and transmit signals to a remote PC (i.e. recordation electronics). In all embodiments, a cam arrangement is provided that selectively and alternatively allows the ball point pen and/or pencil lead feeder as well active stylus to be placed in a use position, for example, by way of a relatively simple twist of the cap portion with respect to the barrel portion.

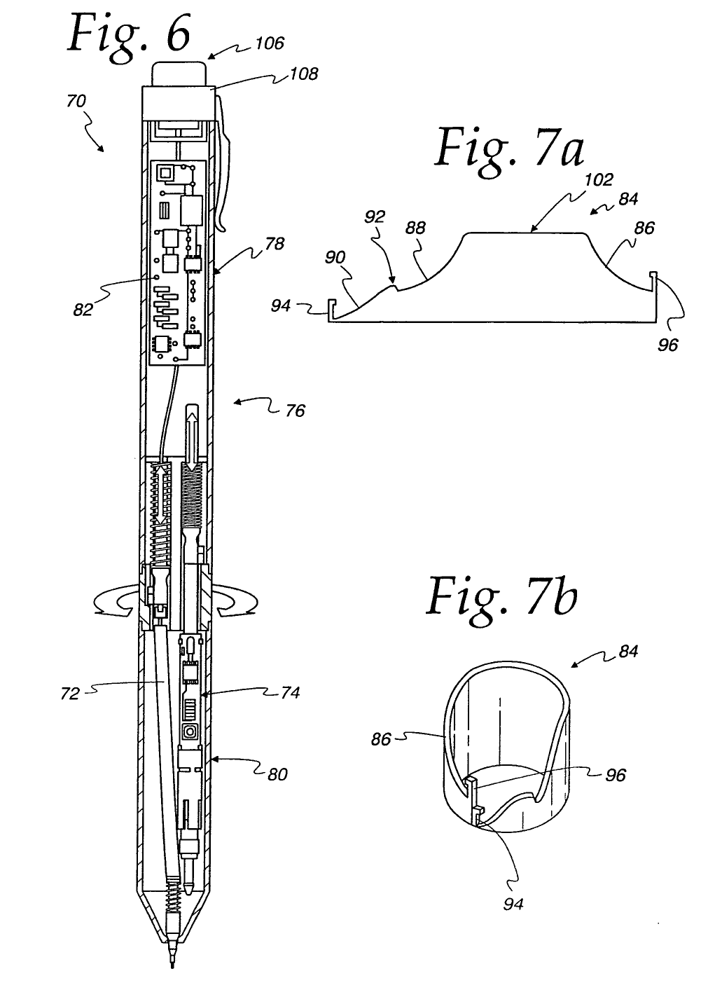

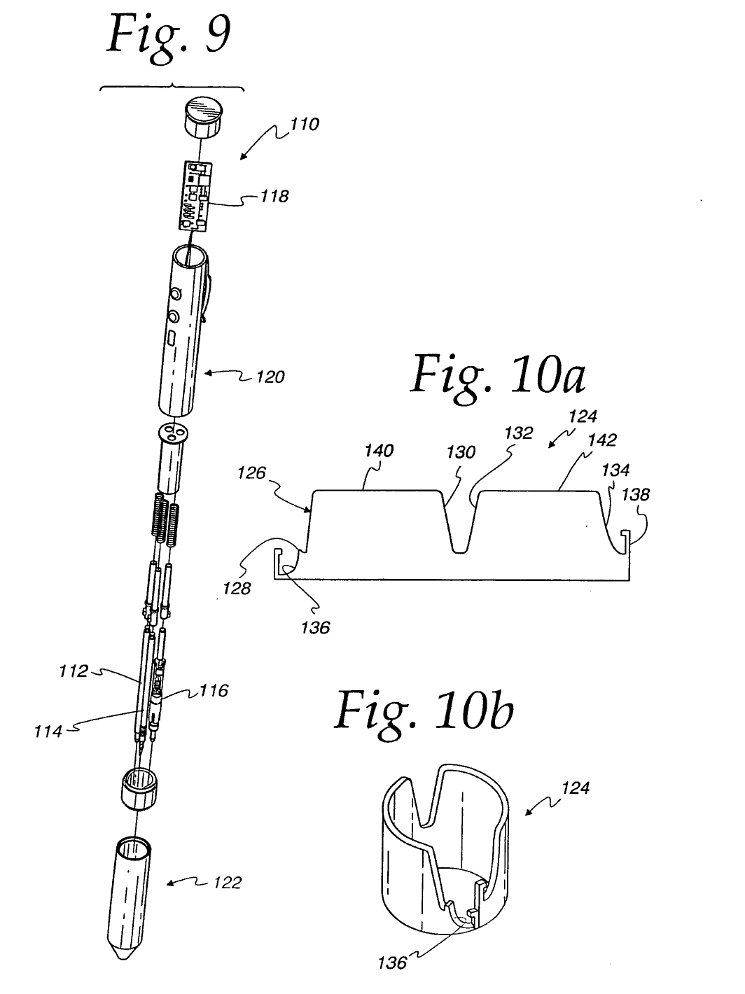

FIGS. 1-5 illustrate a first embodiment of the multi-functional pen input device that includes a ball point pen cartridge, an active stylus and optionally recordation electronics. FIGS. 6-8 illustrate a second embodiment of the invention that includes a pencil lead feeder, an active stylus and optionally recordation electronics. FIGS. 9-14 illustrate a third embodiment of the invention, which includes a ball point pen cartridge, a pencil lead feeder, an active stylus and optionally recordation electronics.

As used herein, the term recordation electronics relates to an electronic circuit including sensors that sense the X and Y movements of the pen input device and a transmitter for transmitting signals representative of the X and Y movements to a personal computer (PC) wirelessly. Recordation electronics is also used herein to include implementations in which the pen input device is connected to the PC by way of a wire and the signals are sent over the wire. Exemplary recordation electronics are disclosed in commonly owned co-pending U.S. patent application Ser. No. 11/287,519, filed on Nov. 23, 2005, hereby incorporated by reference. The principles of the present invention also apply to virtually any pen input device configured for use on a virtual writing surface, for example, as discussed above, all hereby incorporated by reference.

Various conventional active stylus devices are suitable for use with the present invention, for example, model no. +01, as manufactured by OQO, Inc of San Francisco, Calif. Likewise various conventional ball point pen cartridges and pencil lead feeders are suitable for use with the present invention. An exemplary ball point pen cartridge is a model no. M21, as manufactured by Lamy of Germany Pencil lead feeders including the exemplary pencil lead feeder illustrated and described herein are also obtainable from Lamy of Germany. The principles of the present invention are applicable to virtually any active stylus device with or without a battery that can be used as an input device for a digitizer tablet is suitable for use with the present invention. Similarly, virtually any ball point pen cartridge and pencil lead feeder are likewise suitable for use with the present invention.

Referring first to FIGS. 1-5, the multi-functional pen input device, generally identified with the reference numeral 20, includes housing, generally identified with the reference numeral 22, which includes a cap portion 24 and a barrel portion 26. The barrel portion 26 may optionally include a clip 27. The multi-functional pen input device 20 also includes a ball point ink cartridge 28 and an active stylus 30. A pair of cam followers 32 and 34 is used to axially displace the ball point pen cartridge 28 and the active stylus 30, respectively, when the cap portion 24 is rotated with respect to the barrel portion 26, as will be discussed in more detail below. Each cam follower 32 and 34 is formed as an elongated rod with a radial projection 36, 38 on one end. These radial projections 36, 38 ride on a pair of cam surfaces 40 and 42, respectively, on an annular cam 44, best shown in FIGS. 4a and 4b. An extending end of each of the cam surfaces 40, 42 is formed with a stop 41, 43, respectively (FIGS. 4a, 4b). The cam 44 is rigidly secured to the barrel portion 26 of the housing 22 so that it rotates therewith and does not move in an axial direction.

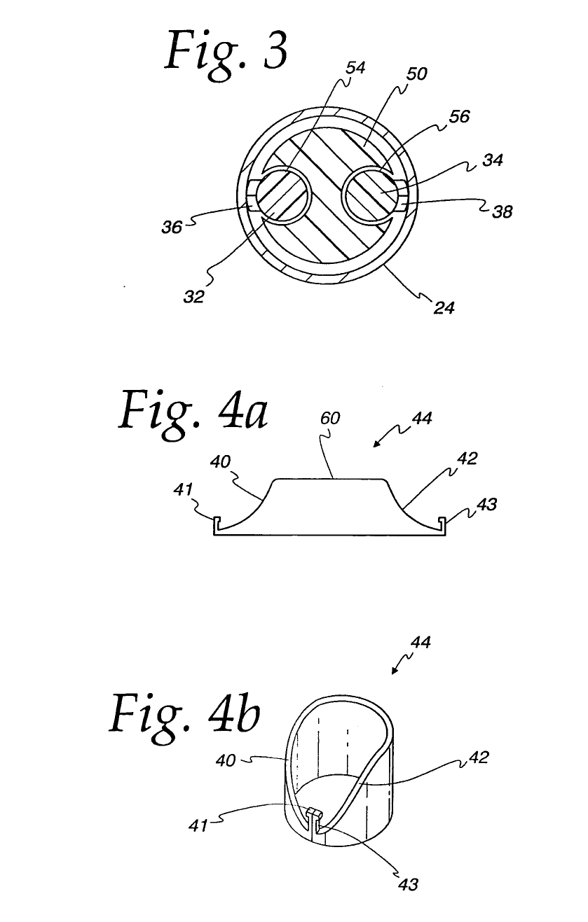

As best shown in 1-3, a pair of biasing springs is used to bias the cam followers 28,30 and thus the ball point pen cartridge 28 an active stylus 30, respectively, downwardly so that the radial projections 36, 38 ride on the cam surfaces 40, 42. The biasing springs 46, 48 are received in a spring retainer 50, best shown in FIG. 3, which is rigidly secured to the cap portion 24 defining a stop surface 52 (FIG. 1) for one end of the biasing springs 46, 48. As best shown in FIG. 3, the spring retainer may be formed as a generally solid cylindrical member with diametrically opposing pseudo-cylindrical through holes 54, 56 that acts as a spring retainer. The cam followers 28, 30 are formed with a bead or increased diameter portion 56, 58 adjacent an opposing end which act as an opposing stop surface for the biasing springs 46, 48.

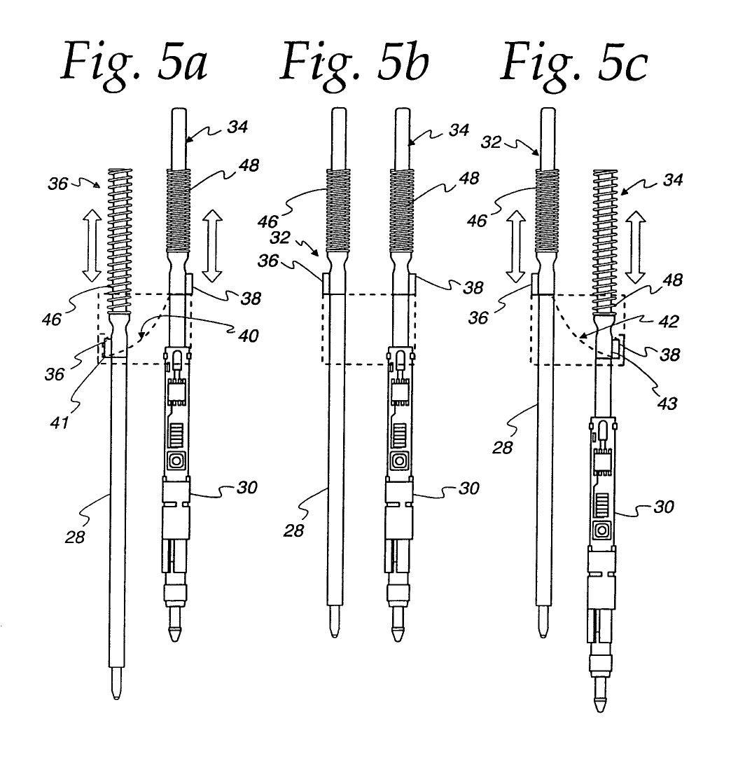

With such a configuration the axial position of the ball point pen cartridge 28 and the electronic stylus 30 is controlled by the position of the radial projections 36, 38 on the cam followers 32, 34, respectively, with respect to the cam surfaces 40, 42, respectively. Thus, rotation of the barrel portion 26 of the housing 22 with respect to the cap portion 24 causes the cam 44 to rotate. As the cam 44 rotates, the radial projections 36, 38 on the cam followers 32, 34 respectively, ride on the cam surfaces as basically shown in FIGS. 5a-5c, causing the ball point pen cartridge 28 and the active stylus 30 to move upwardly and downwardly. In particular, FIG. 5b illustrates a condition when both the ball point pen cartridge 28 and the active stylus 30 are in a retracted poison. In this position, the radial projections 36, 38 on the respective cam followers 32, 34 are both riding on a relative flat surface 60 (FIG. 4a) on the cam 44. In this position, both biasing springs 46, 48 are compressed, thus biasing the respective cam followers 32, 34 and thus the ball point pen cartridge 28 and active stylus downwardly.

As the barrel portion 26 of the housing 22 is rotated in one direction with respect to the cap portion 24, the cam 44 rotates in. This action causes the radial projection 36 on the cam follower 32 to ride down the cam surface 40 (FIG. 4a) causing the cam follower 32 and the ball point ink cartridge 28 to move downwardly in a direction toward the barrel portion to an extended or use position under the influence of the biasing spring 46, as generally shown in FIG. 5a. In a fully extended position, the biasing spring 46 becomes uncompressed. In this position, the active stylus 30 remains in a retracted position since the radial projection 38 continues to ride on the flat surface 60 (FIG. 4a) of the cam 44.

Similarly, as the barrel portion 26 of the housing 22 is rotated in an opposite direction with respect to the cap portion 24, the cam 44 rotates in an opposite direction. This action causes the radial projection 38 on the cam follower 34 to ride down the cam surface 42 (FIG. 4a) causing the cam follower 34 and the active stylus 30 to move downwardly in a direction toward the barrel portion to an extended or use position under the influence of the biasing spring 48, as generally shown in FIG. 5c. In a fully extended position, the biasing spring 48 becomes uncompressed. In this position, the ball point pen cartridge 28 remains in a retracted position since the radial projection 36 continues to ride on the flat surface 60 (FIG. 4a) of the cam 44.

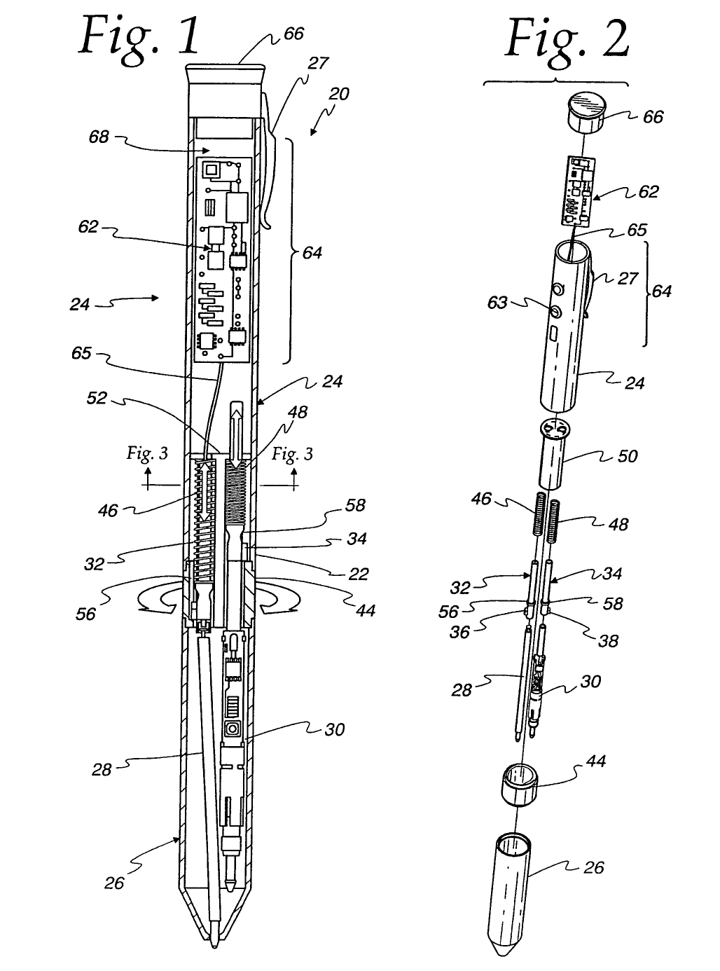

The multi-functional pen 20 may optionally include a recordation electronics module 62. The recordation electronics module 62 may be formed on a relatively small printed circuit board (PCB) and be electrically coupled to a battery (not shown) either carried by the PC card or simply located within the housing 22 and wired to the recording electronics module 62. On or more optional pushbuttons 63 (FIG. 2) may be located on the exterior surface of the barrel portion 24 of the housing 22 which are hard-wired by way of an electrical conductor 65 to the recordation electronics module 64. The PCB is configured with the electronic circuitry for a pen input device for writing on a virtual writing surface and circuitry for transmission of the pen device input signals to a remote PC.

In accordance with another important aspect of the invention, the recording electronics module 62 is disposed in an upper portion 64 (FIGS. 1 and 2) of the cap portion 24 of the housing 22. The top portion of the barrel portion 24 of the housing 22 may be closed by an optional top cap 66. (FIGS. 1 and 2). In particular, as best illustrated in FIG. 1, the multi-functional pen input device 20 is configured so that the selectable ball point pen cartridge 28 and active stylus 30 are located in the barrel portion 26 of the housing 22 and the lower portion of the cap portion 24 of the housing 22, thus leaving a cavity 68 (FIG. 1) in the upper portion 64 of the cap portion 24 of the housing 22 for optionally receiving the recording electronics module 62.

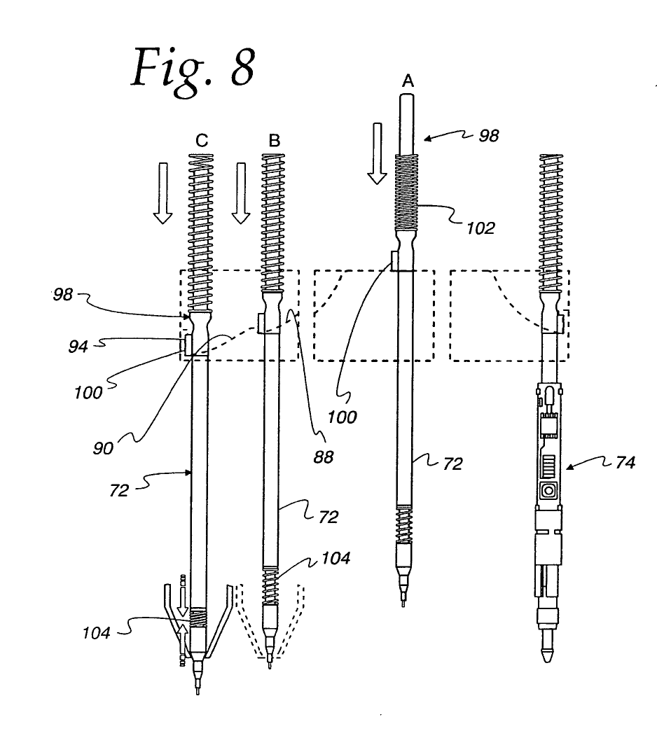

An alternate embodiment of the invention is illustrated in FIGS. 6-8 and is generally identified with the reference numeral 70. The multi-functional pen input device 70 is similar to the multi-functional pen input device 20 with a few differences as discussed below. In particular, the multi-functional pen input device 70 includes a pencil lead feeder 72 and an active stylus, housed in a common housing 76 having a cap portion 78 and a barrel portion 80. The multi-functional pen input device 70 may also optionally be configured with a recordation electronics module 82, as discussed above. One major difference is the configuration of the cam. In particular, the multi-functional pen input device 70 includes an exemplary shaped cam 84, as generally illustrated in FIGS. 7a and 7b. The cam 84 is formed with a first cam surface 86 for controlling the axial movement of the active stylus 74, in a similar manner as discussed above. The cam 84 is formed with two cam surfaces 88, 90 (FIG. 7a) for the pencil lead feeder 72. The cam position 88 is for enabling the pencil lead feeder 72 to advance to an extended or use position, as shown in FIG. 8. The cam surface 90 is used for advancing the lead in the pencil lead feeder 72, as will be discussed in more detail below. A bump 92 forms a detent position between the cam surfaces 88 and 90 and forms a soft stop therebetween. Hard stops at the extended ends of the cam surfaces 90 and 86, respectively.

Turning to FIG. 8, in position A, the pencil lead feeder is illustrated in a retracted position. Similar to the embodiment discussed above, the pencil lead feeder 72 is driven by a cam follower 98, formed with a radial projection 100 on one end and biased downwardly by a biasing spring 102. In this position, the cam follower 98 and thus the pencil lead feeder 72 are in a retracted position. In this position, the biasing spring 102 is compressed and the radial projection 100 rests on a relatively flat surface 102 (FIG. 7a) of the cam 84.

As the barrel portion 80 of the housing 76 is twisted in one direction relative to the cap portion 78, the radial projection 100 on the cam follower 98 rides down the cam surface 88 (FIG. 7a) until it reaches the soft stop 92 defining an extended or use position, as shown in position B in FIG. 8. In order to advance the lead in the pencil lead feeder 72, the cap portion 78 of the housing 76 is rotated an additional amount in the same direction as illustrated in position C (FIG. 8). This action causes the radial projection 100 to ride down the cam surface 90 until it reaches the hard stop 94. In this position a spring 104, provided as part of the pencil lead feeder 72 is compressed, thereby advancing the lead in the pencil lead feeder 72. After the pencil lead is advanced, the cap portion 78 of the housing 76 is rotated in an opposite direction with respect to the barrel portion 78 to return to the use position, illustrated as position B. In this position, the 104 returns to a relaxed position.

In this embodiment, multi-functional pen input device 70 may include an eraser 106. The eraser 106 may be carried by an optional cap 108, used to close the open end of the barrel portion 78 of the housing 76. In this embodiment, the cap 108 may be configured to carry the eraser 106.

FIGS. 9-14 illustrate a third embodiment of the invention. In this embodiment, a multi-functional pen input device 110 is disclosed. The multi-functional pen input device 110 includes a ball point pen cartridge 112, a pencil lead feeder 114, an active stylus 116 and optionally a recordation electronics module 118 housed in a housing formed from a cap portion 120 and a barrel portion 122. The multi-functional pen input device 110 is similar in construction and operation to the multi-functional pen input devices 20 and 70 except as noted below. In particular, the multi-functional pen input device 110 includes a cam 124.

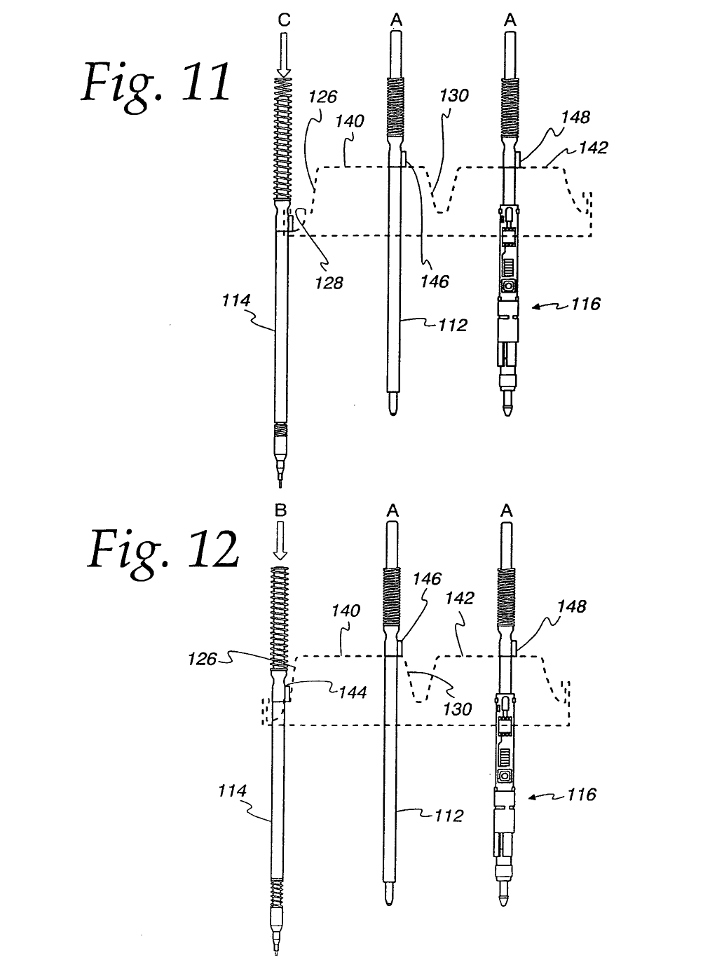

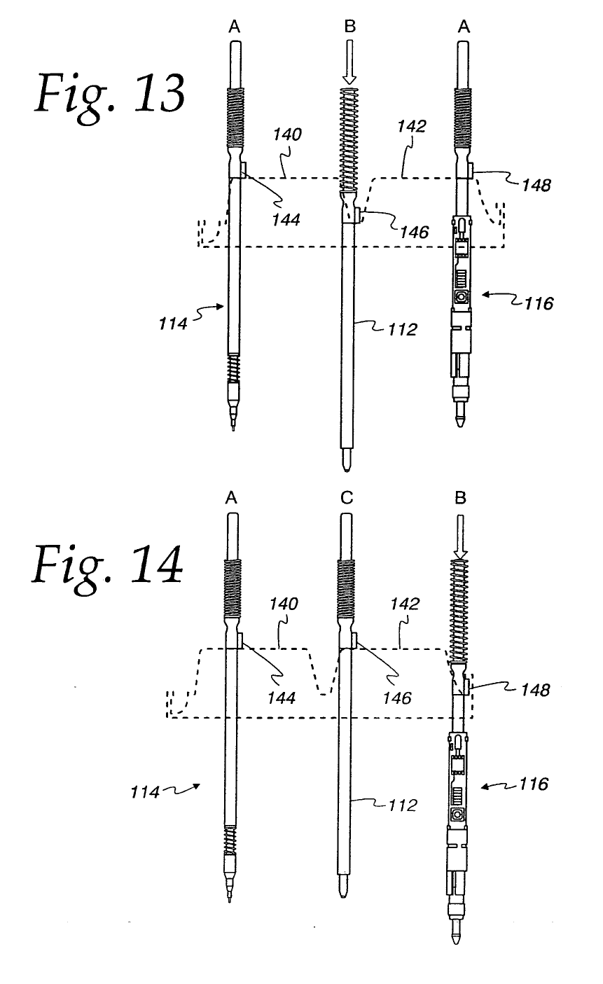

In this embodiment, the cam 124 is formed with multiple cam surfaces 126, 128, 130 132 and 134. The cam surfaces 128 and 130 are formed with hard stops 136, 138 respectively. The cam 124 is also formed with two flat surfaces 140 and 142. As shown in FIGS. 13 and 14, the pencil lead feeder 114 is shown in a retracted position in which its associated radial projection 144 rests on the flat cam surface 140. As the cap portion 120 (FIG. 9) of the housing is rotated in one direction with respect to the barrel portion 122, the radial projection 144 rides down the cam surface 126 thereby extending the pencil lead feeder 114 to the use position, identified as position B in FIG. 12. Continued rotation causes the radial projection to ride down the cam surface 136 until it hits the hard stop 128, illustrated as position C in FIG. 11. As discussed above, this action causes lead to be advanced in the pencil lead feeder 114. Rotation of the cap portion 120 relative to the barrel portion 122 in the opposite direction causes the pencil lead feeder to return to the use position (i.e. position B, FIG. 12) Continued rotation in the same direction causes the pencil lead feeder 114 to return to the retracted position, illustrated as position A in FIGS. 13 and 14.

The ball point pen cartridge 112 is shown in a retracted position in FIGS. 11 and 12, identified as position A. Rotation of the cap portion 120 of the housing with respect to the barrel portion 122 causes the associated radial projection 146 associated with the ball point ink cartridge 112 to ride down the cam surface 130, forcing the ball point ink cartridge 112 to the extended or use position, identified as position B in FIG. 13. Continued rotation causes the radial projection to ride up the cam surface 132 to a retracted position, identified as position C in FIG. 14.

The active stylus 116 is shown in a retracted position in FIGS. 11-13, identified as position A. Rotation of the cap portion 120 with respect to the barrel portion 122 causes its associated radial projection 148 to ride down the cam surface 134 until it hits the hard stop 138, forcing the active stylus 116 to the extended position, identified in FIG. 14 as position B. Rotation in the opposite direction causes the active stylus 116 to return to its retracted position in which its associated radial projection rests on the flat cam surface 142.

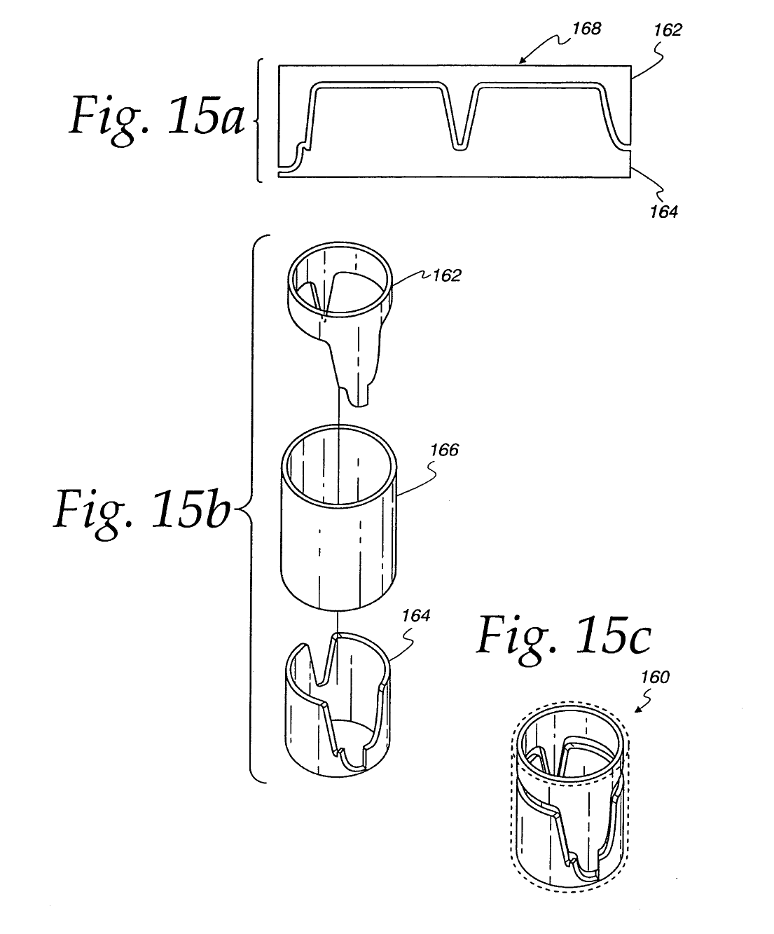

FIGS. 15a-15c illustrate an exemplary configuration of the cam, which eliminates the need for biasing springs for the cam followers. In this embodiment, the cam is formed as a two-piece assembly 160, formed from two complementary portions, an upper cam portion 162 and a lower cam portion 164 having a profile, as generally illustrated with the reference numeral 168. In this embodiment, the radial projections formed on the cam followers, as discussed above, are sandwiched between the complementary cam surfaces of the upper cam portion 162 and the lower cam portion 164. The upper and lower cam portions 162, 164 are rigidly secured to a cap portion 166 of the housing. Thus, as a cap portion 166 of the housing is rotated with respect to the barrel portion of the housing (not shown), the cam followers (not shown) are forced to follow the paths defined by the complementary cam surfaces without the aid of biasing springs.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A multi-functional pen input device comprising:
an electronic stylus having a retracted position and an extended position;
a ball point ink cartridge having a retracted position and an extended position; and
a housing, said electronic stylus and said ball point ink cartridge being configured within said housing to be individually selectable to cause said electronic stylus and said ball point ink cartridge to move from a retracted position to an extended position and from an extended position to a retracted position.

2. The multi-functional pen input device as recited in claim 1, wherein said housing includes a cavity adjacent the top of the housing.

3. The multi-functional pen input device as recited in claim 2, further including a recording electronics module disposed in said cavity.

4. The multi-functional pen input device as recited in claim 1, wherein said housing is formed from a cap portion and a barrel portion.

5. The multi-functional pen input device as recited in claim 4, wherein said device is configured so that rotation of said cap portion with respect to said barrel portion in one direction causes said electronic stylus to be extended and said ball point ink cartridge to be retracted.

6. The multi-functional pen input device as recited in claim 5, wherein said device is configured so that rotation of said cap portion with respect to said barrel portion in a direction opposite said one direction causes said ball point ink cartridge to be extended and said electronic stylus to be retracted.

7. The multi-functional pen input device as recited in claim 5, wherein said device is configured so that rotation of said cap portion with respect to said barrel portion in one direction causes said multi-functional pen input device to be retracted.

8. The multi-functional pen input device as recited in claim 4, wherein said housing includes an annular cam rigidly disposed relative to a portion of said housing and a cam follower associated with each of said electronic stylus and said ball point ink cartridge which ride on said cam and a biasing spring which biases said electronic stylus and said ball point ink cartridge and associated cam followers downwardly.

9. The multi-functional pen input device as recited in claim 1, further including one or more pushbutttons carried by said housing.

10. A multi-functional pen input device comprising:
an electronic stylus having a retracted position and an extended position;
a pencil lead feeder having a retracted position, an extended position and a position for advancing lead; and
a housing, said electronic stylus and said pencil lead feeder being configured within said housing to be individually selectable to cause said electronic stylus and said pencil lead feeder to individually move from a retracted position to an extended position and from an extended position to a retracted position and said pencil lead feeder to and from a position to advance lead.

11. The multi-functional pen input device as recited in claim 10, wherein said housing includes a cavity adjacent the top of the housing.

12. The multi-functional pen input device as recited in claim 11, further including a recording electronics module disposed in said cavity.

13. The multi-functional pen input device as recited in claim 10, wherein said housing is formed from a cap portion and a barrel portion.

14. The multi-functional pen input device as recited in claim 13, wherein said device is configured so that rotation of said cap portion with respect to said barrel portion in one direction causes said electronic stylus to be extended and said pencil lead feeder to be retracted.

15. The multi-functional pen input device as recited in claim 14, wherein said device is configured so that rotation of said cap portion with respect to said barrel portion in a direction opposite said one direction causes said pencil lead feeder to be extended and said electronic stylus to be retracted.

16. The multi-functional pen input device as recited in claim 14, wherein said device is configured so that rotation of said cap portion with respect to said barrel portion in one direction causes said pencil lead feeder to a position to advance lead.

17. The multi-functional pen input device as recited in claim 13, wherein said housing includes an annular cam rigidly disposed relative to said barrel portion of said housing and a cam follower associated with each of said electronic stylus and said pencil lead feeder which ride on said cam and a biasing spring which biases said electronic stylus and said pencil lead feeder and associated cam followers downwardly.

18. The multi-functional pen input device as recited in claim 10, further including one or more pushbuttons carried by said housing.

19. A multi-functional pen input device comprising:
an electronic stylus having a retracted position and an extended position;
a ball point ink cartridge having a retracted position and an extended position;
a pencil lead feeder having a retracted position, an extended position and a position for advancing lead;
a housing, said electronic stylus and said ball point ink cartridge being configured within said housing to be individually selectable to cause said electronic stylus, said ball point ink cartridge and said pencil lead feeder to individually move from a retracted position to an extended position and from an extended position to a retracted position and said pencil lead feeder to and from a position to advance lead.

20. The multi-functional pen input device as recited in claim 19, wherein said housing includes a cavity adjacent the top of the housing.

21. The multi-functional pen input device as recited in claim 20, further including a recording electronics module disposed in said cavity.

22. The multi-functional pen input device as recited in claim 19, wherein said housing is formed from a cap portion and a barrel portion.

23. The multifunctional pen input device as recited in claim 22, wherein said device is configured so that rotation of said cap portion with respect to said barrel portion in one direction causes said electronic stylus to be extended and said ball point ink cartridge to be retracted.

24. The multifunctional pen input device as recited in claim 23, wherein said device is configured so that rotation of said cap portion with respect to said barrel portion in one direction causes said ball point ink cartridge to be extended and said electronic stylus and said pencil lead feeder to be retracted.

25. The multifunctional pen input device as recited in claim 23, wherein said device is configured so that rotation of said cap portion with respect to said barrel portion in one direction causes said pencil lead feeder to be extended and said ball point ink cartridge and said electronic stylus to be retracted.

26. The multi-functional pen input device as recited in claim 25, wherein said device is configured so that rotation of said cap portion with respect to said barrel portion such that further rotation in said one direction causes said pencil lead feeder to a position that advances lead.

27. The multi-functional pen input device as recited in claim 22, wherein said housing includes an annular cam rigidly disposed relative to said barrel portion of said housing and a cam follower associated with each of said electronic stylus, said ball point ink cartridge and said pencil lead feeder, which ride on said cam and a biasing spring which biases said electronic stylus, said ball point ink cartridge and said pencil lead feeder and associated cam followers downwardly.

28. The multi-functional pen input device as recited in claim 19, further including one or more pushbuttons carried by said housing.

29. The multi-functional pen input device as recited in claim 1, further including a two-piece annular cam with complementary cam surfaces, a plurality of cam followers with extending radial projections that are adapted to be sandwiched between said complementary cam surfaces.

30. The multi-functional pen input device as recited in claim 10, further including a two-piece annular cam with complementary cam surfaces, a plurality of cam followers with extending radial projections that are adapted to be sandwiched between said complementary cam surfaces.

31. The multi-functional pen input device as recited in claim 19, further including a two-piece annular cam with complementary cam surfaces, a plurality of cam followers with extending radial projections that are adapted to be sandwiched between said complementary cam surfaces.
